(19) United States
(12) Patent Application Publication
(10) Pub. No.: US 2018/0101775 A1
(43) Pub. Date: Apr. 12, 2018

(54) ANALYTICS OF VEHICLE DATA

(71) Applicant: Bosch Automotive Service Solutions Inc., Warren, MI (US)

(72) Inventor: James Fish, Birmingham, MI (US)

(21) Appl. No.: 15/290,683

(22) Filed: Oct. 11, 2016

(51) Int. Cl. G06N 5/04; G06F 17/30

(52) U.S. Cl. CPC G06N 5/04; G06F 17/30554; G06F 17/30477

(57) ABSTRACT

A system that uses analytics such as prescriptive analytics to formulate a prediction in order to provide a user with a recommendation so that user can make an informed decision. Data may be received for various databases on network computers such as original current manufactured databases, parts databases, diagnostic databases, maintenance databases and location databases. Based on the recommendation, the user interface of a relevant provider is launched so that the user may start a process of the recommendation.

### FIELD OF THE INVENTION

The present invention relates generally to analytics of vehicle data. More particularly, the present invention relates to using prescriptive analytics to analyze vehicle data and provide conclusions regarding a vehicle.

### BACKGROUND OF THE INVENTION

Vehicles such as an automobile, airplane, train, boat and the like are vital to a vibrant economy as they help to move people and deliver goods. Owners of the vehicles may be corporations, such as Robert Bosch GmbH, individuals, and the like and as owners they face certain milestones that require various decisions to be made regarding the vehicle. These decisions include whether to buy, sell, donate or lease the vehicle, whether to repair or defer the repair of the vehicle, and whether to add expensive accessories or replace major components such tires and the like.

The impetus of these decisions includes ending of a lease term (whether to lease again or purchase the vehicle) for the vehicle, personal changes (new baby, relocation, mobility issues, increased work obligations), maintenance (whether to fix the A/C or replace the tires) and the like. It's important for the owners to make a well-informed decision as there are economic, time commitments and other consequences of the decision.

Accordingly, it is desirable to provide an owner with as much information as possible regarding the maintenance state or status of the vehicle so that the owner can make a well-informed decision.

### SUMMARY OF THE INVENTION

The foregoing needs are met, to a great extent, by the present invention, wherein in one aspect a system is provided that in some embodiments include various databases that store information about vehicles that can be aggregated and analyzed at a remote computer so that certain conclusions or recommendations can be provided to the user.

In accordance with one embodiment, a processor-implemented method of rating a vehicle programmed in a non-transitory processor-readable medium and to execute on one or more processors of a computer configured to execute the method that includes receiving a vehicle search input by a user at a decision computer, receiving information related to vehicle data including previously repairs of the vehicle, location data, and weather data from databases of remote computing devices, wherein the databases dynamically and continuously receive additional vehicle repairs data, location data, and weather data, providing a recommendation based on the vehicle repairs data, location data and weather data, and automatically launching a user interface of a vehicle provider on the decision computer based on the recommendation.

In accordance with another embodiment, a non-transitory machine-readable storage medium comprising machine-readable instructions for causing a processor of a computing device to execute a method that includes receiving a vehicle search input by a user, receiving information related to vehicle data including previously repairs of the vehicle, location data, and weather data from databases of remote computing devices, wherein the databases dynamically and continuously receive additional vehicle repairs data, location data, and weather data, providing a recommendation based on the vehicle repairs data, location data and weather data, and automatically launching a user interface of a maintenance provider on the computing device based on the recommendation.

In still another embodiment, a system for rating a vehicle that includes a diagnostic tool configured to communicate with an ECU in a vehicle to retrieve vehicle diagnostic information, a vehicle data source including at least one or more of historical data point selected from a group consisting of a previously retrieved vehicle diagnostic information, a previous repair of the vehicle, a previous repair of other vehicles of the same make and model, a location of the vehicle, a weather corresponding to the location of the vehicle, a warranty data related to the make and model of the vehicle, a warranty data connected to a component of the vehicle, a maintenance record of the vehicle, a recall of the vehicle, a bulletin published for the vehicle, a top known fix and issue compiled for the vehicle, an average lifespan of the vehicle, and an average lifespan of the component of the vehicle, and a computer configured to communicate with the diagnostic tool to retrieve the vehicle diagnostic information from the diagnostic tool, communicate with the vehicle data source to retrieve the at least one historical data point, and the computer programmed to, upon receipt of the vehicle diagnostic information and the at least one historical data point, output a prediction based on a correlation between the vehicle diagnostic information and the at least one historical data point.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a system having a computer connected to other computing devices that communicate with each other via a network according an embodiment of the invention.

FIG. 2 illustrates a method of providing conclusions or recommendations to the user to make an informed decision according to an embodiment of the invention.

### DETAILED DESCRIPTION

The invention will now be described with reference to the drawing figures, in which like reference numerals refer to like parts throughout. Embodiments of the invention allow an owner of a vehicle to make a well-informed decision such as whether to buy, sell, donate or lease the vehicle, whether to repair or defer such repair of the vehicle, whether to pay someone to repair the vehicle or do it herself, whether to add expensive accessories or replace major components such tires and the like based on a current or future maintenance status of the vehicle. The maintenance status of the vehicle may be based on analytics, such as prescriptive analytics that includes an engine that receives information from a variety of sources that are internal to the vehicle (ECU) and/or external to the vehicle (databases), and normalizing the information to predict as accurate as possible the likelihood of a component or system failure for the vehicle taking into account the vehicle's year, make, model, engine, mileage, previous owners (whether the previous owners tend to be hard on their vehicles), previous maintenance information, and other histories of the vehicle (previous accident, etc.) and the like. In one embodiment, a key source of information can be from an archive of repair orders that details repairs that have been performed on vehicles. The relevant data, for example, would be the part replaced and other factors contributing to the failure of the part such as age of the part (or of the vehicle), geo-location of the vehicle, mileage of the vehicle, operating hours on the vehicle, and the like.

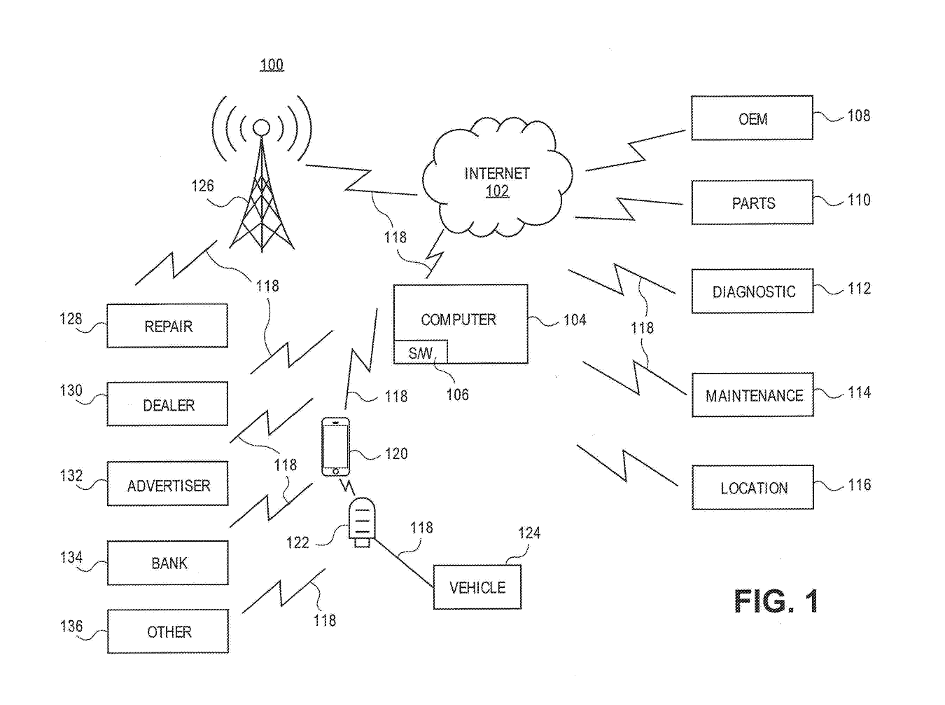

FIG. 1 illustrates a system 100 having a computer 104 connected to other computing devices that communicate with each other via a network according an embodiment of the invention. More particularly, the system 100 includes a network 102, such as the Internet, the decision computer 104 having the analytics engine or software 106, various networked computers 108, 110, 112, 114, 116, 128, 130, 132, 134, the consumer computing device such as the wireless device 120, the vehicle diagnostic tool 122, the vehicle 124 and communication tower 126 that are all interconnected with each other via a two-way wireless and/or wired connection 118.

The connection 118 may be the same or a different type of connection from each other. Wired connections may include USB (universal serial bus), FireWire, serial, parallel and the like, while wireless connections may be via Wi-Fi, Bluetooth, ZigBee, near field communications, infrared, radiofrequency, satellite, cellular and the like. Other connections may be a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a Personal Communications Service (PCS), using known protocols such as the Global System for Mobile Communications (GSM), CDMA (Code-Division Multiple Access), W-CDMA (Wideband Code-Division Multiple Access), Near Field Communication (NFC), Wireless Fidelity (Wi-Fi), and the like, and/or a combination of thereof

As shown in FIG. 1, the decision computer 104 may act as a hub to send, receive and process various information or data from the various networked computers, 108, 110, 112, 114, 116, the wireless device 120, the vehicle diagnostic tool 122, dealer repair computer 128, vehicle dealer computer 130, online advertiser computer 132, a bank computer 134, and other computing devices 136. As will be shown below, the decision computer 104 processes the various information in order to predict the likelihood of one or more component of the vehicle will fail during a certain period of time so that a person can make certain decisions such as whether to repair the vehicle, buy the vehicle, lease the vehicle, sell the vehicle or trade in the vehicle and the like. In another embodiment, the prediction may simply be a report on the current status of the vehicle with no issues, such as a vehicle that is only 1 years old and has 10,000 miles. In a further embodiment, as more and more information is being received and processed, the prediction is more accurate as it is based on dynamic information being that in a continuous basis instead of static information that may be stale.

In one embodiment, the networked manufacturer computer 108 may include databases related to a vehicle manufacturer like Ford, BMW, Toyota, Boeing, Electro-Motive Diesel, a component manufacturer such as Robert Bosch GmbH, and the like. The information in the database regarding the various manufacturers include information such as components for the vehicle including related drawings, specifications, tolerances (based on weather, location, operating conditions, etc.), warranty, maintenance records, recalls, bulletins, top known fixes and issues, operating conditions, weather conditions, average lifespans, and the like.

In another embodiment, average lifespan for the vehicle or a component of the vehicle may include historical and real-time data including operating and weather conditions that are used to calculate the average lifespan for the component. The historical and real-time data may include the average time in which the components will fail or begin to fail (below acceptable working or standard safety level) based on one or more of the following year, make, model, engine, miles, operating time (time of operation, duration of operation, etc.), number parts replacements, weather conditions, all over a certain period time (months, years, etc.) and the like. In another embodiment, the operating conditions may include data on weather conditions (heat, rain, cold/snow), component operation time of day/night, length of operating time, how to vehicle was driven (fast acceleration, hard braking, slow driving, swerving, etc.), miles driven per operation of the vehicle, amount of city or highway driving, congested area or not and the like during operation of the component that would affect the average lifespan of the component.

For example, the component such as the transmission may have a decreased average lifespan if the vehicle has high miles but driven mainly in the city, which results in frequent starting and stopping of the vehicle causing excessive wear and tear on the transmission. In contrast, driving at a steady speed for longer periods of time, such as on a highway, results in less wear and tear on the transmission. If the vehicle tends to be subjected to cold weather, such as being in northern region of the country (Minnesota), the average lifespan of the transmission will decrease due to freezing and contracting caused by the cold weather including leaking of fluids from the seals.

The parts network computer 110, in one embodiment, may include parts databases having data of parts manufacturer, distributors, resellers and retailers, such as NAPA, Robert Bosch GmbH, Delphi, Pep Boys, Sears and the like. The databases may include historical and current data such as drawings, specifications, instruction and repair manuals including difficulty and length of repairs, tolerances (based on weather, operating conditions, etc.), warranty, maintenance records, recalls, bulletins, average lifespan, location of the parts and/or user, inventory, resupply orders for components, pricing, purchase schedules for components and the like. The parts network computer 110 databases can be used to determine the likelihood the component will need to be purchased over a period time such as weeks, months and years and thus, indirectly indicating the likelihood of the component needing to be replaced over the same period time.

For example, if the part, such as the windshield wiper is located or purchased from stores located in a region of the country (Seattle) that is known to rain more frequently than other regions of the country then the likelihood that the windshield wiper would need to be replaced within the next six months is relatively high. This is compared to windshield wipers that are utilized in dry regions of the country such as Arizona that would not need to be replaced as frequently. Further, the number of placed purchase schedules and/or the resupply orders for the windshield wipers provide clues as to the likelihood of the windshield wipers in that region would need to be replaced sooner rather than later. That is, over a period of time, such as three months, if there is the steady resupply order by Pep Boys (Seattle location) for windshield wipers, then there is a high likelihood that the windshield wipers will need to be replaced for vehicles in the same region as that Pep Boys store.

In another embodiment, the diagnostic network computer 112 may have diagnostic databases including diagnostic tool manufacturer, distributors, resellers and retailers, such as NAPA, Robert Bosch GmbH, Delphi, Pep Boys, Sears and the like. The databases may include historical and current data such as drawings, specifications, diagnostic software, diagnostic trouble codes definitions, instruction and repair manuals including top fixes, repair time, difficulty and costs, tolerances (based on weather, location, operating conditions, etc.), warranty, maintenance records, recalls, bulletins, average lifespan for a component, location of the parts and/or user, inventory, resupply orders, pricing, purchase schedules and the like.

Using the databases such as diagnostic software and diagnostic trouble codes (DTCs) definitions can help to predict the likelihood of a component failure. Additionally, based on the diagnostics, the owner can decide whether to repair the issue itself or higher mechanic to make the repairs. DTCs are set in the vehicle when the relevant electronic control unit (ECU) detects an issue with the relevant component such as a transmission. Thus, the transmission (ECU) can set DTCs when it detects, for example, a fault with the circuit that operates the torque converter clutch solenoid or other issues with the transmission. In one embodiment, the set DTCs can be retrieved using a diagnostic tool 122, such as the U-Scan™ from Bosch Automotive Service Solutions Inc. located in Warren, Mich., that is communicating with an ECU in a vehicle 124. The U-Scan alone or in combination with the wireless device 120 can use diagnostic software (stored locally or remotely) to interpret the set DTCs or send the DTCs to the diagnostic network computer 112 having the diagnostic database for further processing.

In another embodiment, the diagnostic tool 122 may be utilized to retrieve and/or store vehicle diagnostic information such as DTCs, brake pad sensors, tire pressure, oil gauge, engine temperature, mileage, last vehicle inspection, service or repair, warranty information, fuel tank, fuel consumption rate, amount of remaining battery charge (electric or hybrid vehicle), battery consumption rate, last oil change, air bag deployments and the like. Sensors of the vehicle may provide driving characteristics of the driver such as hard braking, excessive acceleration, excessive braking, swerving or other evasive maneuvers, crashes, excessive lane changes, and the like.

The DTCs are used along with the diagnostic software to determine the most likely fixes and the associated cost of repairs. Additionally the diagnostic information such as hard braking, excessive acceleration can be used to determine the type of driving the vehicle is subjected to and indirectly the effects of components of the vehicle such as brakes and transmission. Thus, the owner can determine based on the associated cost of repairs, such as replacing the clutch or the transmission, and the type of driving whether to sell the vehicle or repair the vehicle and the like.

Further, the bulletins or other notices can provide information about the likelihood of a component will need to be replaced in the near future. For example, if the EPA regulations require conversion from one type of refrigerant to another type of refrigerant, the A/C system of the vehicle may need to be replaced or converted within the stated amount of time in order to comply with the regulations. The conversion or replacement will undoubtedly be a large expense that will affect the owner's decision whether to make the conversion or replacement or simply sell, or purchase a new vehicle.

The maintenance network computer 114, in one embodiment, may include diagnostic and maintenance databases including OEM (original equipment manufacturer) such as Toyota, Ford, GM, BMW and the like, CARFAX® and repair facilities such as Pep Boys, Sears, AAA, gas stations and the like. A vehicle's maintenance history may be stored on the maintenance network computer 114 and accessed in order to determine the state of the vehicle. That is, a review of the vehicle's maintenance history may reveal that the vehicle has had a long standing issue with its A/C system and would ultimately need to have the A/C system repaired or totally replaced. Additionally, a review of the vehicle's maintenance history may reveal that the owner has kept up with the required maintenance such as replacing the timing belt, tune-ups, oil changes, transmission flush, and the like and that the vehicle would more likely than not be relatively trouble-free for a predetermined period time such as the next six months or a year. The maintenance network computer 114 may be configured to aggregate the maintenance records of the vehicle regardless of where the vehicle was maintenance. That is, the owner may have the old changed at a Jiffy Lube, have his A/C flushed at the dealer and in his brakes service at Brake Check, but that all of repair facilities can be networked to send information to or be accessed by the maintenance network computer 114.

In another embodiment, the vehicle location network computer 116 may include local information and weather databases for the location where the vehicle is mainly driven. For example, local information may include traffic patterns, terrain information (mountains, hills, etc.), population, number of highways and local roads, maintenance schedule and condition of the highways and roads. Weather databases may contain information regarding amount of rain and snow, days of extended heat or cold, amount of hail over a predetermined period time, such as six months, a year, five years, a decade and the like.

The location information where the vehicle is mainly driven may indicate the current and future condition the vehicle. That is, if the vehicle is driven in densely populated cities (New York, Los Angeles, etc.), excessive wear and tear on the vehicle may more than if the vehicle is driven in less populated cities like Kalamazoo, MI given the likelihood of interactions with more vehicles (bus, cars, bikes) in the more populated cities. This would lead to excessive wear and tear on vehicle components such as the transmission, tires and brakes leading to a more likelihood of the vehicle needing to be repaired more often over a period of time. Additionally, if the vehicle is located in a wet or cold region, the exterior of the vehicle may be damaged (rusting) prematurely due to excessive moisture or salt from the treated highways.

The decision computer 104 includes in its memory the analytics engine or software 106 that will analyze the information from one or more of the various databases of the networked computers 108, 110, 112, 114, 116, wireless device 120, and the vehicle diagnostic tool 122. Additionally, the information in the various databases is tagged to the vehicle identification information such as year, make, model, engine, and mileage. The analytics engine 106 may include analytics capabilities such as a prescriptive analytics engine, which may be configured to be utilized with information that relates to a vehicle. In general, prescriptive analytics engine may use optimization and simulation algorithms, machine learning, statistical models, and the like to provide possible outcomes in the future so that a user has actionable insights to make an informed decision. The optimization algorithms may be used to normalize certain sets of data so that a better prediction model may be made. That is, the prescriptive analytics engine provides estimates about the likelihood of the future event based on identifying patterns in the data and applying statistical models to define relationships between the data sets. The data may include historical and real-time data being received on a constant basis. Additionally, the prescriptive analytics engine may also be configured to provide recommendations for action items based on the prediction.

One or more of the data from the databases contained in the networked computers 108, 110, 112, 114, 116, data in the wireless device 120, and data in the vehicle diagnostic tool 122 received by the decision computer 106 via connection 118, internet 102 and/or tower 126 (cellular or other communication tower) can be used to provide the predictive analytics results. However, the accuracy of the predictive analytics results will likely be higher as more data from various sources are utilized.

Once the predictive analytics conclusions or recommendations are produced, additional actions may be presented to the user. For example, if one of the conclusions is to purchase a new or used vehicle, the user will be directed to an interface or a webpage of a computer of a dealer 130 such as CarMax, BMW or Lexus in order to start the process of purchasing a vehicle. The user can query for the desired vehicle based on factors such as make, model, year and type of engine.

In one embodiment, the user's calendar (on the wireless device 120 or other computing device) may be accessed to determine availability for test drive. Vehicle preferences may also be utilized to determine which dealer's computer should the user be directed to. In still another embodiment, the user may be directed to vehicle dealers that may have the most reliable vehicle based on information contained in the decision computer 104.

In addition to or alternatively, the user can also be directed to the interface or webpage of a computer of a bank 134 in order to start the process of obtaining a loan for the vehicle. In another embodiment, the bank or financial institution can also be the bank or financial institution that holds the note or lease on the current vehicle under consideration. This way, the decision computer can take into consideration the remaining vehicle loan or lease amounts including the monetary and lengths amounts paid or remaining. That is, if the remaining lease amounts are larger than the cost to repair the component, then the recommendation may be to repair the component. In another embodiment, the user may be directed to a website containing his credit score so that he can determine his credit worthiness.

In another embodiment, if one of the conclusions is to repair the vehicle in order to prevent potential damage, then the user will be directed to interface or webpage of the computer of a dealer or repair facility 128 in order to schedule the repair and obtain estimates for costs, time of repair and/or difficulty of the repair. In still another embodiment, if one the conclusion is to sell the vehicle, the user can be directed to an interface or a webpage of a computer of an online advertiser, such as eBay, Edmunds.com, or Cars.com in order to start the process of advertising the vehicle for sale. Depending on the conclusions, there may be other computers that the users can be directed to such as a parts computer if the user in a DIYer. However, in one embodiment, the user is directed automatically to the appropriate interfaces or webpages depending on the conclusions so that the user can start the appropriate process.

In one embodiment, as part of the service to provide the decision computer to a user at a nominal fee or no fee, the recommended repair facilities, advertisers, banks, dealers (based on the conclusions and/or recommendations) may be pre-chosen for a fee paid to part of the recommended network. This allows flexibility for the owner of the decision computer 104 to either charge the user or the recommended entity or combination thereof

It should be noted that although the decision computer 104, the networked computers 108, 110, 112, 114, 116, wireless device 120, and the vehicle diagnostic tool 122 are discussed herein as being separate devices, on one embodiment, the devices may all be included on one device such as the decision computer 104. That is, the decision computer 104 includes the necessary components such as processors, memories (RAM and storage), input and output devices, software and the like in order to receive, store and process all the information as it they were separate devices.

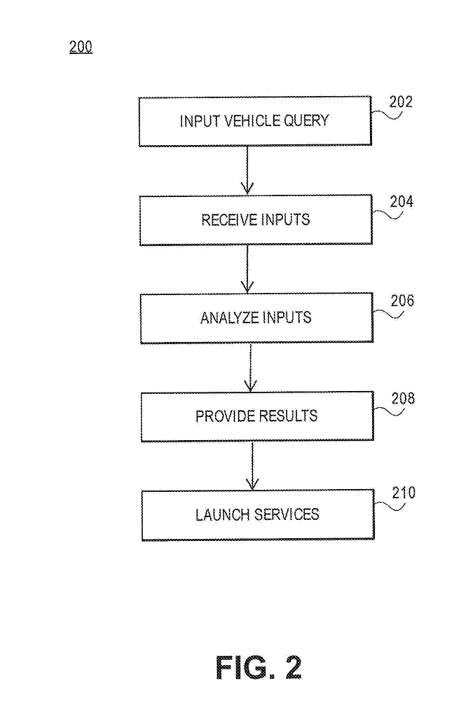

Turning to FIG. 2, which illustrates a method 200 of providing conclusions or recommendations to the user to make an informed decision. The decision computer 104, which acts as a hub to send, receive and process various information or data from the networked computers 108, 110, 112, 114, 116, 128, 130, 132, 134, the consumer computing device 120, the vehicle diagnostic tool 122 and other computing device, determines the state of the vehicle and the likelihood of the costly repairs that would be needed for a given period of time such as six months or year. This allows the user to make an informed decision such as whether to fix the vehicle, buy the vehicle, lease the vehicle, sell the vehicle, defer repairing the vehicle or trade in the vehicle and the like at the appropriate time.

Although the method 200 is described using the decision computer 104 any other computing device such as the wireless device 120 or other computing devices 136 may also be used alone or in conjunction with the decision computer 104. The method starts at step 202, where the user inputs the vehicle query into the decision computer 104 which then searches the relevant databases. In one embodiment, a user may search for data for a 2013, BMW 3351, turbo inline 6 having 48,000 miles contained on the networked computers using the decision computer 104 or via the wireless device 120 (accessing the decision computer 104 or itself). This can be done on a graphical user interface (not shown) or through voice recognition.

At step 204, the decision computer 104 may receive data such as average lifespan for a component and warranty information for the component may be retrieved from the networked manufacturer computer 108, data such as pricing for a part may be retrieved from the parts network computer 110, data such as diagnostic trouble codes definitions and top fixes may be retrieved from the diagnostic network computer 112, data such as the BMW's maintenance history may be retrieved from the maintenance network computer 114, and data such as local and weather information may be retrieved from the vehicle location network computer 116.

At step 206, once all the relevant data is received, the data is processed using the prescriptive analytics engine 106 including normalizing the data, using optimization and simulation algorithms, machine learning, statistical models, and the like to provide possible outcomes in the future so that a user has actionable insights to make an informed decision. In one embodiment, the BMW is coming off of a standard three-year lease (allowance 30,000 miles) and the lessee must decide whether to purchase the vehicle or purchase or lease another vehicle. From the relevant databases, the data includes that the vehicle has higher than average miles (based on the average of 12,000 miles per year), is located in San Francisco, which has lots of hills and is known to be cold and damp, driven mainly in the city with a history of quick acceleration and stopping due to heavy traffic, set DTCs related to transmission issues, and the vehicle has been properly maintenance but the transmission has been serviced multiple times and the brakes have not been replaced. Additionally, in that region transmissions are placed on orders more often than transmissions ordered in warmer climates. Based on the data, the prescriptive analyzer engine 106 estimates that repair of the transmission and brake pads would be needed in the next 6 to 8 months, which is beyond the lease period and any applicable warranty for the vehicle. Estimated repairs for the transmission and brakes and other potential repairs would be around $3,500 to $4,000 in the next 6 to 8 months. The user may select the period ahead of time in which the prescriptive analytics engine 106 would use to base its conclusions and/or recommendations, the period of time may include the next three months, six months, year, or multiple years and the like.

At step 208, based on the information that the BMW would need to have costly repairs, the prescriptive analyzer engine 106 would recommend that the lessee purchase or lease a new vehicle instead of buying the currently leased BMW. At step 210, based on the conclusions or recommendations, the lessee can be directed (or automatically) to the appropriate interface(s) or webpage(s) depending on if the vehicle should be turned in, purchased, repaired or a different new or used vehicle would need to be purchased.

In one embodiment, if one of the conclusions is to purchase a new or used vehicle, the user will be directed to an interface or a webpage of a computer of a dealer 130 such as CarMax, BMW or Lexus in order to start the process of purchasing a vehicle. The user can query for the desired vehicle based on factors such as price, mileage, make, model, year and type of engine. Additionally, the decision computer can also alert the user of vehicle that matches the user's selected factors including sending a link of the webpage to the user for that vehicle and/or automatically opens that webpage on the decision computer and/or the wireless device.

In addition to or alternatively, the user can also be directed to the interface or webpage of a computer of a bank 134 in order to start the process of obtaining a loan for the vehicle. In addition to or alternatively, according to another embodiment, if one of the conclusions is to repair the vehicle in order to prevent potential damage, then the user will be directed to interface or webpage of the computer of a dealer or repair facility 128 in order to schedule the repair and obtain estimates for costs, time of repair and/or difficulty of the repair. This allows the user to determine whether to repair the vehicle herself or have it repaired professionally. In still another embodiment, if one the conclusion is to sell the vehicle, the user can be directed to an interface or a webpage of a computer of an online advertiser, such as eBay, Edmunds.com, or Cars.com in order to start the process of advertising the vehicle for sale. Depending on the conclusions, there may be other computers that the users can be directed to such as a parts computer if the user is a DIYer. However, in one embodiment, the user is directed automatically to the appropriate interfaces or webpages depending on the conclusions so that the user can start the appropriate process.

Although most vehicles still run on gas powered, electric and hybrid vehicles are making headways. It should be noted that electric vehicles do not have typical components such as a transmission that a gas powered vehicle would have but the prescriptive analytics engine may be used for other components such as batteries which makes up a substantial cost of the electric vehicle.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Further in accordance with various embodiments of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein. These dedicated hardware devices include the required bus communication system, displays, memories, input and output devices and the like.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A processor-implemented method of rating a vehicle programmed in a non-transitory processor-readable medium and to execute on one or more processors of a computer configured to execute the method, comprising:
receiving a vehicle search input by a user at a decision computer;
receiving information related to vehicle data including previously repairs of the vehicle, location data, and weather data from databases of remote computing devices, wherein the databases dynamically and continuously receive additional vehicle repairs data, location data, and weather data;
providing a recommendation based on the vehicle repairs data, location data and weather data; and
automatically launching a user interface of a vehicle provider on the decision computer based on the recommendation.

2. The method of claim 1, wherein the recommendation include selling the vehicle, repairing the vehicle, purchasing a new vehicle or leasing the new vehicle.

3. The method of claim 1, wherein information related vehicle data includes receiving vehicle data from a vehicle diagnostic tool or a diagnostic database.

4. The method of claim 1, wherein information related vehicle data includes receiving vehicle data from parts database or an original equipment manufacturer database.

5. The method of claim 1, wherein the vehicle provider is a vehicle dealer for new and used cars.

6. The method of claim 1, wherein the vehicle provider is a bank where the vehicle is financed.

7. The method of claim 1, wherein the vehicle provider is a repair facility where the user is able to schedule a repair.

8. The method of claim 1, wherein information related to vehicle data include make, year, and model of the vehicle.

9. The method of claim 1, wherein information related to vehicle data include remaining length of a lease or vehicle loan of the vehicle.

10. The method of claim 1, wherein information related to vehicle data include amounts of a component that is preordered for a region where the vehicle is located.

11. A non-transitory machine-readable storage medium comprising machine-readable instructions for causing a processor of a computing device to execute a method of:
receiving a vehicle search input by a user;
receiving information related to vehicle data including previously repairs of the vehicle, location data, and weather data from databases of remote computing devices, wherein the databases dynamically and continuously receive additional vehicle repairs data, location data, and weather data;
providing a recommendation based on the vehicle repairs data, location data and weather data; and
automatically launching a user interface of a maintenance provider on the computing device based on the recommendation.

12. The method of claim 11, wherein information related to vehicle data includes diagnostic data from a vehicle diagnostic tool or a diagnostic database.

13. The method of claim 11, wherein information related vehicle data includes receiving vehicle data from parts database or an original equipment manufacturer database.

14. The method of claim 11 further comprising accessing the user's calendar to schedule a repair appointment.

15. The method of claim 11, wherein information related to vehicle data include make, year, and model of the vehicle.

16. The method of claim 15, wherein information related to vehicle data include amounts of a component that is preordered for a region where the vehicle is located.

17. The method of claim 11, wherein information related to vehicle data include how the vehicle was driven.

18. The method of claim 11, wherein the recommendation includes a provider of services that has paid a fee to be recommended for the service.

19. The method of claim 11, wherein information related to vehicle data include a regulation that would require a component of the vehicle to be converted in order to comply with the regulation.

20. A system for rating a vehicle, comprising:
a diagnostic tool configured to communicate with an ECU in a vehicle to retrieve vehicle diagnostic information;
a vehicle data source including at least one or more of historical data point selected from a group consisting of a previously retrieved vehicle diagnostic information, a previous repair of the vehicle, a previous repair of other vehicles of the same make and model, a location of the vehicle, a weather corresponding to the location of the vehicle, a warranty data related to the make and model of the vehicle, a warranty data connected to a component of the vehicle, a maintenance record of the vehicle, a recall of the vehicle, a bulletin published for the vehicle, a top known fix and issue compiled for the vehicle, an average lifespan of the vehicle, and an average lifespan of the component of the vehicle; and
a computer configured to:
communicate with the diagnostic tool to retrieve the vehicle diagnostic information from the diagnostic tool;
communicate with the vehicle data source to retrieve the at least one historical data point; and
the computer programmed to, upon receipt of the vehicle diagnostic information and the at least one historical data point, output a prediction based on a correlation between the vehicle diagnostic information and the at least one historical data point.
